(19) United States
(12) Patent Application Publication
(10) Pub. No.: US 2007/0143990 A1
(43) Pub. Date: Jun. 28, 2007

(54) Cable connector handling tool

(76) Inventors: Kevin B. Larkin, Pebble Beach (CA); Stephen J. Weinert, Arlington, TX (US)

Correspondence Address: JOHANNES SCHNEEBERGER, 118B MENDOCINO ST., BRISBANE, CA, 94005, US

(21) Appl. No.: 11/317,856

(22) Filed: Dec. 22, 2005

(51) Int. Cl. H01R 43/20

(52) U.S. Cl. 29/747; 29/748; 29/750; 29/758

(57) ABSTRACT

A tweezers type cable connector handling tool features two levers in guiding interaction via respective guiding faces to increase angular lever stiffness. The handling tool features also a central cable receiving channel to hold the extending cable of a connector clamped at the gripping end of the tool and to keep the cable bend radius from being bent more than standards provide for. The connector may be permanently clamped via a ratchet closure, a latching pin lock or a lever rotation joint lock such that the clamped connector may be conveniently handled via the handling tool without need to simultaneously apply a manual damping force. The handling tool may also feature an integrated flash light approximately tangential pointing towards the tool's gripping end. The flash light's housing is integrated in a bending stress communicating fashion while keeping the overall contour of the respective lever continuous.

### FIELD OF INVENTION

The present invention relates to handling tools for fiber optic jumper, strand and cable connectors. In particular, the present invention relates to tweezers type handling tools for fiber optic cable connectors.

### BACKGROUND OF INVENTION

Ever increasing miniaturization of data cable connectors in general and optical fiber cable connectors in particular makes insertion, removal and handling of cable connectors more difficult to accomplish. Fiber optic cable connectors in particular need to be handled with care to avoid contaminating contact with the connector's optical front end. Moreover, optical cable connectors ends need to be cleaned on a recurring basis.

In industrial applications, cable connectors are often densely arrayed on panels such that the high volume of connected cables may shield off ambient illumination to a large degree. Additional illumination is therefore desirable at the attachment location of the handled cable connector.

Also, despite the cable connectors small size, considerable forces may be required to insert and remove the cable connector. This in combination with fiber optic cables or shielded coaxial cables increased bending stiffness poses additional challenges for a precise, efficient and reliable insertion and removal of cable connectors. There exist also standards for minimum cable bending radii which may be inadvertently exceeded in cases where the cable extending from the clamped connector is not supported in the handling tool. Therefore, there exists a need for a connector handling tool that keeps the cable in substantial alignment with the connector immediately adjacent the clamped connector. The present invention addresses this need.

A number of prior art connector handling tools attempt to address the particular challenges of handling modern cable connectors. There exist tools having an angled grip portion on the opposite end of the grasping claws. Such tools provide ergonomic transfer of manual push and pull forces on the expense of cable connector fine control and risk affecting adjacent connectors due to their size and clumsy functionality.

There are other tools similarly configured like tweezers for increased positioning control of the cable connector on the expense of reduced manual push and/or pull force transfer. Such tools also require the manual connector grasping force being simultaneously applied with push/pull forces, which degrade handling flexibility. Therefore, there exists a need for a cable handling tool that provides maximum positioning control of the cable connector and at the same time maximum manual push and pull force transfer, preferably with manual connector grasping force being separately applicable. The present invention addresses this need.

Simultaneous illumination of the connector insertion location has been addressed in prior art connector handling tools by attaching a flash light peripherally or centrally on the handling tool. Central flashlight attachment provides only very limited illumination of the insertion side, since most of the beam cone is obstructed the tool's front portion and the connector and its cable held in the tool. Peripheral attachment on the other hand provides satisfactory illumination but requires an extended tool length since the tool has to be held in hand behind the attached flash light. Therefore, there exists a need for an illumination solution that provides unobstructed illumination while the connector handling tool may be hand held at an approximately equal gripping end offset as the flash light. The present invention addresses also this need.

Tweezers type handling tools commonly feature two members joint at a pivoting end opposite a gripping end and are hand held in between. The long distance between gripping end and pivoting end introduces increased instability of the grasping faces at the gripping end and frequently causes an offset condition which could induce trouble to adjacent connectors when the tweezer lever slips off the connector being held. A deviation torque induced by unbalanced contact pressure in the grasping faces and/or unbalanced manual clamping force may induce excessive angular deflection of the grasping faces such that the connector may eventually laterally eject from its position between the two opposing grasping faces. Unbalanced grasping face contact pressure is a particular problem with connectors having a large ratio of clamping height to clamping width. Therefore, there exists a need for tweezers type handling tool having features opposing effects of deviation torque. The present invention addresses this need.

Unbalanced grasping face contact pressure occurs also in cases of connectors being combined with cables of increased stiffness such as fiber optic cables. Where the cable handling tool holds only the connector itself, the cable commonly laterally emerges from in between the handling tool. Depending on the cables stiffness a certain momentum is thereby induced on the connector. Therefore, there exists a need for a connector handling tool that provides for an insulation of cable torque from the grasped connector by additionally holding both the connector and the immediately adjacent cable portion in alignment within the handling tool. The present invention addresses also this need.

### SUMMARY OF INVENTION

A tweezers type cable connector handling tool features two levers extending between a connector gripping end and an opposite pivoting end. Each lever has a grasping face at the gripping end for holding the cable connector. Each lever also features one of two guiding faces in guiding interaction with each other such that a deviation torque eventually resulting from unbalanced grasping face contact pressures and/or unbalanced hand clamping forces is communicated between the two levers. Angular deformation of the grasping faces is kept consequently to a minimum. The handling tool provides also for a connector cable receiving channel positioned in between the two levers and in between the gripping end and the pivoting end. The receiving channel is longitudinally aligned with the two grasping faces such that a cable extends substantially straight from a corresponding connector clamped between the grasping faces. Keeping the cable straight immediately behind the clamped connector assists in keeping grasping face contact pressures balanced and deviation torque within predictable limits. It further assists in isolating cable forces from the clamped connector.

The levers feature also first/second tapers on their outside faces such that a tool grasping force between the two grasping faces is amplified while the handling tool is pushed/pulled towards/away from the gripping end. The boundary contours of first/second tapers increase thereby towards the center of the manual clamping forces externally applied on the handle levers. A bending stress distribution in the handle levers is consequently balanced between pivoting end and gripping end. This contributes to an ergonomic and lightweight configuration of the handling tool.

Guiding faces may be provided by a post extending from a first inner face of one of the two levers into a cavity embedded in a second inner face of one other of the two levers. The receiving channel may be provided by two adjacent posts arrayed with a cable channel spacing substantially in direction of the handling tool's pivoting axis.

The handling tool may further alternately feature a ratchet closure, a latching pin lock or a lever rotation lock for locking the tool grasping force and thereby securing the cable connector without need to further apply the manual clamping force. The cable connector is consequently easily held and manipulated without need to simultaneously and continuously apply the manual clamping force.

The handling tool also features an integrated flash light approximately tangentially pointing towards the gripping end. The flash light's housing is a continuation of the outside contour of the lever in which the light source is integrated. The flash light's housing is integrated in a bending stress communicating fashion in the respective lever.

The grasping faces are provided either by removable attached rubber layers or by a grasping boot that may be snapped on a corresponding boot receiving nose at the gripping end of a respective handle lever. The grasping boots may be interchanged to adopt the handling tool to various types of cable connectors.

### BRIEF DESCRIPTION OF THE FIGURES

FIG. 1 is a perspective view of a cable connector handling tool of the present invention with a representative cable connector and cable secured in the handling tool.

FIG. 2 is the perspective view of the handling tool of FIG. 1 with representative ratchet closure and latching pin lock. One grasping boot is removed.

FIG. 3 is a top down view of the handling tool of FIG. 1 with both grasping boots removed.

FIG. 4 is a side view of the handling tool of FIG. 2.

FIG. 5 is a side view of two levers.

Fig. A-A is a cross section indicated in FIG. 5 by section line A-A.

Fig. B-B is a cross section indicated in FIG. 5 by section line B-B.

FIG. 6 is the perspective view of a partially exploded handling tool with the integrated flash light and a joint lever in removed position.

FIG. 7 is a second perspective view of an embodiment of the invention including grasping boots with guides and cable receiving channel and a ratchet closure having a joint.

### DETAILED DESCRIPTION

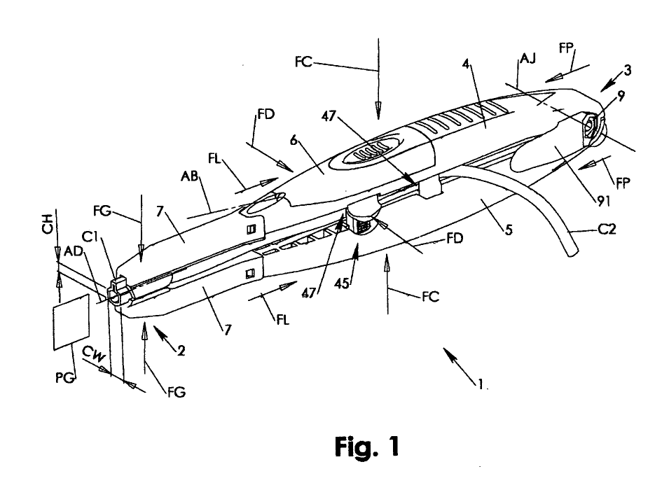

A tweezers type cable connector handling tool 1 in the following called tool 1 is shown in FIG. 1 clamping a connector C1 and holding an immediately adjacent connector cable C2 in substantial alignment with the connector C1. The connector C1 is clamped by grasping face clamping pressure resulting from opposing tool grasping forces FG, which in turn result from externally applied manual clamping forces FC transmitted via respective levers 4, 5. The clamping forces FC center approximately there, where boundary contours of the levers 4, 5 are at a maximum. At that location, the levers 4, 5 may be ergonomically held in hand and the manual clamping forces FC applied by the operator's hand squeezing the two levers 4, 5 towards each other.

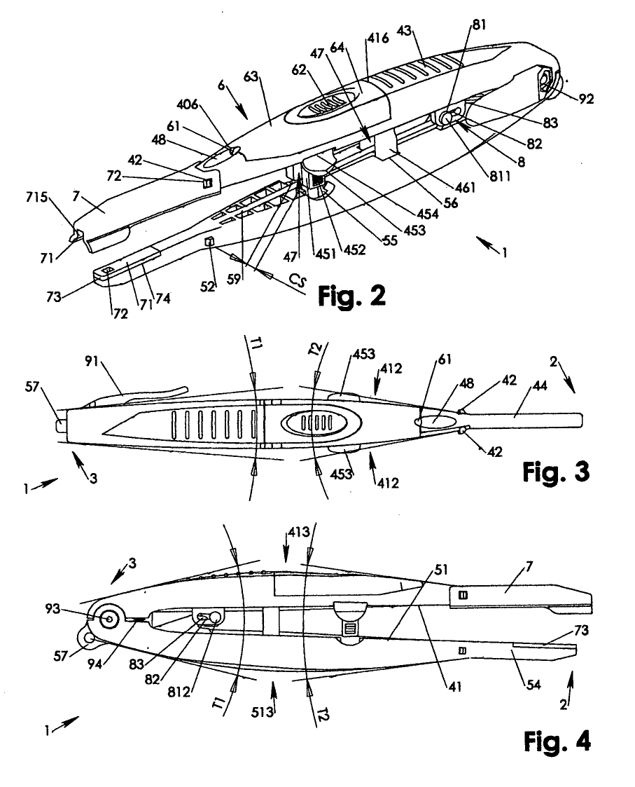

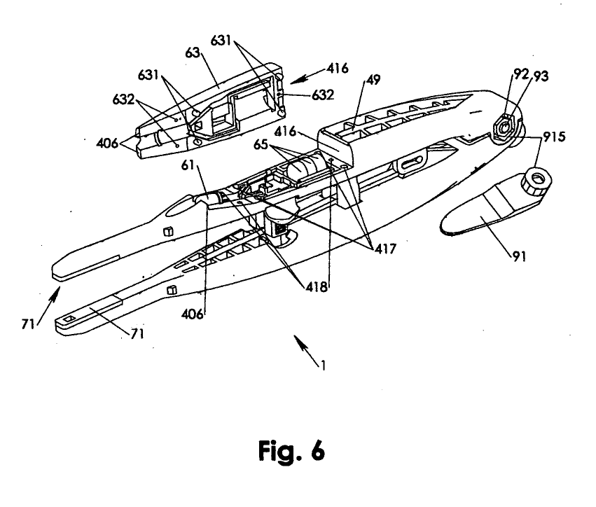

The tool grasping force FG is applied within the grasping plane PG geometrically defined as a normal plane to the pivot axis AJ. Manual clamping force FC is most likely out of plane with grasping plane PG due to the naturally non symmetric hand squeeze as may be well appreciated by anyone skilled in the art. Also, the grasping face contact pressures may be off balance due to imperfect fit of connector C1 with grasping faces 71 (see FIGS. 2, 4, 6) and/or inadvertent out of plane grasping of the connector C1 as it may well occur under practical working conditions. Unbalance of the grasping face contact pressure may be aggravated by a large ratio of clamping height CH to clamping width CW. Unbalanced grasping face contact pressure and out of plane clamping forces FC likely result in a deviation torque TD (see Fig. B-B) in direction around the deviation axis AD that extends between the gripping end 2 and the pivoting end 3.

The clamped connector C1 is inserted at its respective assembly location via tool 1 by a hand applied push force FP. The clamped connector C1 is removed from its respective assembly location via tool 1 by a hand applied pull force FL. Push and pull forces FP, FL may also be out of grasping plane PG and additionally contribute to undesirable deviation torque TD.

The tool 1 may feature an integrated flash light 6 with its illumination axis AB extending approximately tangential away from the outside contour of the respective lever 4 and in plane with the grasping plane PG. The illumination axis AB exits between the clamping force FC center and the gripping end 2 providing illumination unimpeded by the operator's hand, the connector C1 or the connector cable C2. At the same time, the tool 1 may be hand held in close proximity to the gripping end 2 warranting maximum control and external force transmission efficiency between the operator's hand and the clamped connector C1.

Referring also to the remained of the Figures, the tool 1 features first and second levers 4, 5 extending between the tool's 1 gripping end 2 and pivoting end 3. Each of the levers 4, 5 have respective grasping faces 71 facing each other. The two levers 4, 5 are rotatably connected at a joint 9. The two levers 4, 5 pivot around pivot axis AJ. A biasing spring 94 may push the levers 4, 5 away from each other. Angular movement may be limited by well known rotation stops in the joint 9.

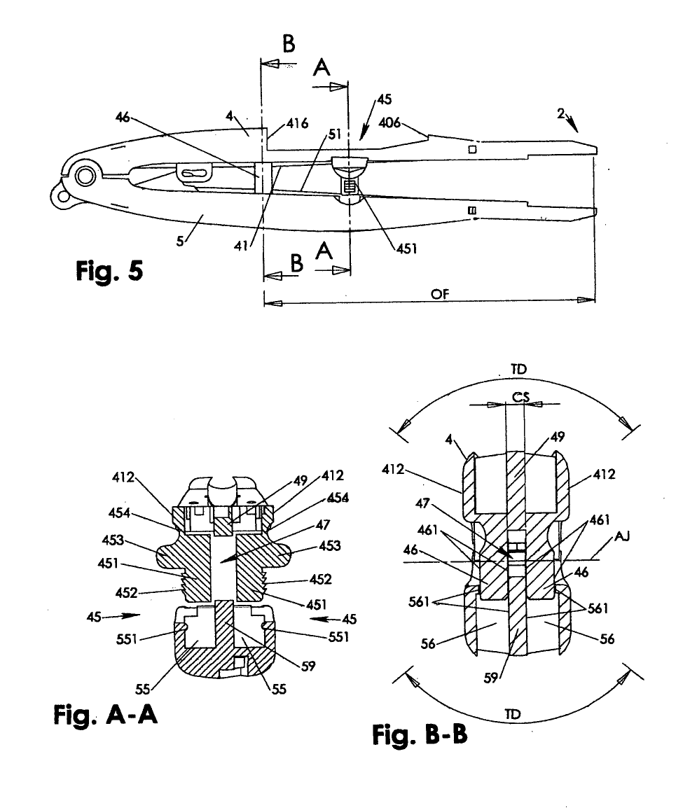

In the preferred case of the tool 1 being fabricated from plastic material, limited material stiffness of the levers 4, 5 requires communication of the deviation torque TD between the two levers 4, 5 to keep angular deflections of the grasping faces out of the grasping plane PG to a minimum. In that context and in reference to FIGS. 5, A-A, B-B, a first guiding face 461 extends from the first lever 4 in an approximate offset OF from the gripping end 2 towards the second lever 5. The first guiding face(s) 461 face(s) substantially in axial direction with respect to the pivoting axis AJ. A second guiding face 561 extends from the second lever 5 in the approximate offset OF from the gripping end 2. The second guiding face(s) 561 is (are) in a guiding interaction with a respective first guiding face 461 such that a deviation torque TD is communicated between the two levers 4, 5 via respective guiding faces 461, 561.

The tool further features a connector cable receiving channel 47 positioned in between the two levers 4, 5 and in between the gripping end 2 and the pivoting end 3. The receiving channel 47 is longitudinally aligned with the grasping faces 71. Consequently, a cable C2 extending immediately adjacent from a connector C1 clamped in between the grasping faces 71 is substantially aligned with the clamped connector C1.

Referring to FIGS. 3, 4, the two levers 4, 5 may provide a first taper T1 tapering down towards the pivoting end 3 such that the tool grasping forces FG are amplified while the tool 1 is hand held pushed by the manual pushing force FP via the first taper T1 in direction towards the gripping end 2. The first taper T1 is adjacent the pivoting end 3 such that a first boundary contour increase of at least one of the two levers 4, 5 increases in direction away from the pivoting end 3 and towards the center of the respective manual clamping force FC. The two levers 4, 5 may also provide a second taper T2 tapering down towards the gripping end 2 such that the tool grasping forces FG are amplified while the tool 1 is hand held pulled by the manual pulling force FL via the first taper T1 in direction away from the gripping end 2. The second taper T2 is adjacent the gripping end 2 such that a second boundary contour increase of at least one of the two levers 4, 5 increases in direction away from the gripping end 2 and towards the center of the respective manual clamping force FC. The boundary contour increases towards the clamping force FC center provide for a balanced bending stress distribution of the levers 4, 5 between the gripping end 2 and pivoting end 3 as may be well appreciated by anyone skilled in the art.

The first taper T1 and/or the second taper T2 may be in plane with the grasping plane PG or may be two dimensional tapers. The tapers T1, T2 are preferably symmetrical with respect to the deviation axis AD for a balanced communication of pulling forces FL and/or pushing forces FP as may be clear to anyone skilled in the art.

Referring to FIG. 5, B-B, the first guiding face 461 may be provided by a post 46 protruding from a first inner face 41 of the lever 4 and extending into a cavity 56 embedded in a second inner face 51 of the second lever 5. The cavity 56 provides the second guiding face 561. Two posts 46 may be provided adjacent to each other and arrayed with a channel spacing CS substantially in direction axially with respect to the pivoting axis AJ. The two posts 46 define thereby the connector cable receiving channel 47.

Referring to FIGS. 1, 5, A-A, the tool 1 may feature a ratchet closure 45 including a first ratchet face 452 resiliently forced via lever 4 towards an opposing second ratchet face 551 of the lever 5 while the two ratchet faces 452, 551 interact with each other. The two ratchet faces 452, 551 may be disengaged from each other against the resilient ratcheting force by an external disengaging force FD applied via a disengaging feature 453. The first ratchet face 452 may be provided by a post 451 protruding from the disengaging feature 453 and extend into a cavity 56 embedded in the second inner lever face 51. The cavity 56 features the second ratchet face 551. The disengaging feature 453 is in a hinging connection 454 with the first lever 4. The hinging connection 454 may be a well known resilient film joint transferring the ratcheting force from the first lever 4 onto the disengaging feature 453. As may be well appreciated by anyone skilled in the art the resilient ratcheting force may result from an angular deflection of the post 451 and the disengaging feature 453 from their natural position opposed by the stiffness of the first lever 4 and the resilient film joint 454.

Two of the disengaging features 453 may be oppositely placed on opposing outside side faces 412 of the first lever 4 such that the respective ratcheting forces are externally overcome by opposing and neutralizing external disengaging forces FD. At the same time, the two posts 451 of the two respective disengaging features 453 may be arrayed with the channel spacing CS substantially in direction axially with respect to the pivoting axis AJ thereby defining the connector cable receiving channel 47. The cable channel spacing CS may be sufficiently larger than a maximum diameter of cable C2 to warrant the disengaging of the two pairs of respective ratchet faces 452, 551 irrespective the cable C2 being present in the receiving channel 47.

Referring to FIGS. 2, 4, 6, the grasping faces 71 may be provided by a rubber layer 73. The rubber layer 73 may feature a perforation 72 for selectively grasping the connector C1. The rubber layer 73 may be removable attached to a corresponding lever 4, 5 by an adhesive layer 74. The adhesive layer 74 may be of velcro.

Referring to FIGS. 1, 2, 4, 6, the tool 1 may include a grasping boot 7 removable snapped on a correspondingly shaped boot receiving nose 44, 54 of respective levers 4, 5 extending the length of the lever arms. The grasping boot 7 may feature the grasping face 71, which may be two dimensionally shaped in conjunction with well known shape particularities of various well known connectors as may be well appreciated by anyone skilled in the art. The two dimensional shape does include a grasping face recess 715 that conforms to the irregular face of the connector.

The grasping boot 7 may have a cavity fit snugly fitting the receiving nose 44. The grasping boot 7 may snap in via snap its perforation 72 on a corresponding snap hook 42, 52.

Referring to FIGS. 1, 2, 5, 6, the integrated flash light 6 is pointing substantially tangential towards the gripping end 2. The housing 63 is integrated in the lever 4 such that bending stresses resulting from manual clamping force FC in the lever 4 are communicated across the housing 63 via stress interfaces 406, 416. The flash light 6 may alternately or additionally be integrated in lever 5. The flash light 6 includes a light source 63 in the preferred configuration of a diode. The lever 4 features a light channel 48 for unimpeded light propagation from the recessed light source 16 towards the gripping end 2. Light source 63 and a number of miniature batteries 65 are embedded and held in position between lever 4 and the housing 63. A light switch 62 is held in the housing 63 via a switch cover 64. The flash light 6 may include well known other components such as contacts, cables and the like. The housing 63 is positioned on the lever 4 via corresponding positioning features 631, 417 and attached on the lever 4 via attachment features 632, 418. Attachment screws acting in a well known fashion via attachment features 632, 418 are omitted for simplicity in the Figures.

In the preferred case of the tool 1 being made of plastic material, the levers 4, 5 are fabricated with an internal rib configuration including keels 49, 59 that extend centrally between pivot end 3 and gripping end 2 symmetrically with respect to the grasping plane PG. The keel width may be selected in conjunction with the cable channel spacing CS such that the keel 59 may propagate past the cavities 55, 56 with continuous width. In case of lever 4 featuring the flash light 63, the keel 49 is interrupted between stress communicating interfaces 406, 416. The housing 63 acts similar to a wedge between the stress communication interfaces 406, 416 and bridges bending stresses across the gap of the keel 49. The overall stiffness of the lever 4 remains consequently similar to the stiffness of lever 5 irrespective the material removed from lever 4 to provide space for the flash light 6. The outside shape of the housing 63 is a continuation of the lever's 4 outside shape such that the operator's hand may conveniently hold the tool 1 in close proximity to the gripping end 2.

The tool 1 may also include a latching pin lock 8 in between the levers 4, 5. The latching pin lock 8 may have a latching pin 81 extending substantially parallel with respect to the pivot axis AJ. Both latching pin ends 811, 812 may be externally accessible for moving the latching pin 81 along a latching cam 82 of the lever 4 for interlocking with a closure hook 83 of the lever 5 while the levers 4, 5 are in a connector grasping position with respect to each other as illustrated in FIG. 1. The latching pin lock 8 may be alternately employed to the ratchet closure 45.

The tool 1 may further include a joint lever 91 attached to the joint 9 via a joint axle preferably made of a nut 93 and a screw 92. The nut 93 may be screwed on the screw 92. One of the nut 93 and the screw 92 may be rotationally and axially secured in the joint 9 and one other of the screw 92 and the nut 93 may be rotationally and axially rigid connected with the joint lever 91, which in turn is rotationally free held in the joint 9. Joint lever 91 and joint 9 define together a rotational snap guide 915 such that the joint lever 91 may be snap rotated at least between a joint 9 lock position and a joint 9 release position. In the lock position the nut 92 and the screw 93 are tightened with respect to each other such that the joint 9 is rotationally fixed. In the release position the joint 9 is rotational free. The joint lever 91 may be a well known pocket clip. The joint lock mechanism described in this paragraph may be alternately employed with the ratchet closure 45 or the latching pin lock 8.

Levers 4, 5 may feature a grip 43 along their respective top and bottom outside faces 413, 513. The grip 43 may be of soft rubber comolded with the structural portions of the levers 4, 5. Lever 5 may also feature a strap ring 57 at the pivoting end 3. Functions and features described in conjunction with levers 4, 5 may be employed vice versa as may be well appreciated by anyone skilled in the art.

The tool 1 is operated by hand holding it approximately where the levers 4, 5 have their boundary contours at a maximum. A connector C1 may be inserted with its immediately adjacently extending cable C2 in the open receiving channels 47 followed by grasping the connector C1 between the grasping faces 71. The connector C1 is then clamped by applying the manual clamping forces FC. The two levers 4, 5 may be fixed in its clamping position to each other automatically by the ratchet closure 45 or manually via latching pin lock 8 or above described joint lock. Following the clamping step, the connector C1 may be conveniently inserted, removed and/or otherwise securely handled without need to continuously apply the clamping forces FC and without particular influence of the cable's C2 bending stiffness. The flash light 6 may be employed at any time by actuating the light switch 62. The connector C1 may be released from the tool 1 by applying the external disengaging force(s) FD in case of an employed ratchet closure 45 or alternately by unlocking the latching pin lock 8 or the joint lock.

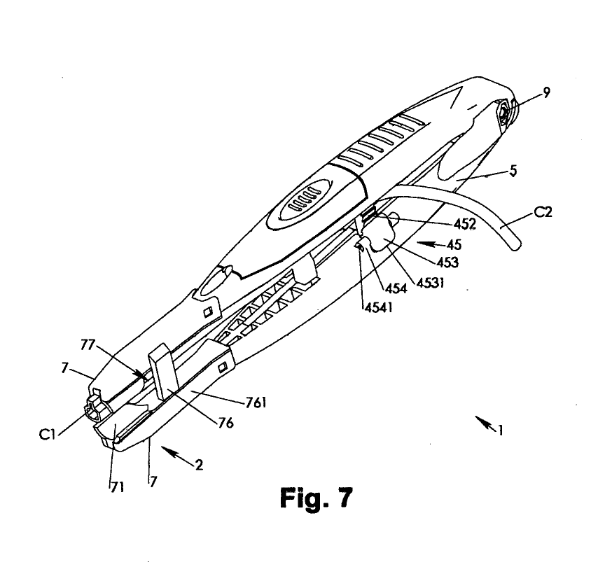

FIG. 7 depicts a connector handling tool 1 with a ratchet closure 45 having its disengaging feature 453 rotatable held via hinge pin 4541 of the hinging connection 454. The resilient ratchet force may be provided by a well known spring acting in between the disengaging feature 453 and the respective lever 5 at which the disengaging feature 453 is rotatable held. While the connector handling tool 1 is forced into closed position by applying the manual clamping force FC, the disengaging feature 453 ratchets along the respective ratchet face 452. Placing the ratchet closure 45 approximately in the middle between joint 9 and gripping end 2 utilizes the levers 45 inherent bending resilience for a smooth application of tool grasping force FG irrespective the ratchet teeth spacing as may be well appreciated by anyone skilled in the art. To disengage the ratchet closure 45, the external disengaging force is applied at the distal end 4531 of the disengaging feature 453 against the spring member resilient ratchet force such that the ratchet face 452 is set free.

Also depicted in FIG. 7 are embodiments of the grasping boots 7 in which at least one of the grasping boots 7 has an on-boot cable receiving channel 77 provided in between two of the boot post 76 oppositely positioned similar as taught in the above for the posts 46. Guiding interaction may be established between inner faces of the boot posts 76 and laterally outward facing guiding faces 761 of the other grasping boot 7. The on-boot cable receiving channel 77 may be conveniently configured for a particular connector cable C2 cross section and/or diameter. As a favorable result, the connector handling tool 1 may be easily adapted to broad variety of connectors C1 and cables C2 be merely adjusting the grasping boots 7. For a simplified exchange and/or replacement of grasping boots 7, a single grasping boot 7 may be held by single snap hook 42, and its corresponding perforation 72. Due to the close proximity of boot posts 76 to the grasping faces 71, precise in plane PG grasping of the grasping faces 71 is warranted in cases of grasping boots 7 having extended lengths and/or small cross sections.

Accordingly, the scope of the invention described in the Figures and in the above is set forth by the following claims and their legal equivalent:

What is claimed is:

1. A tweezers type cable connector handling tool, comprising:
a. a connector gripping end;
b. a pivoting end opposite said connector gripping end;
c. a first and a second handle lever extending between said connector gripping end and said pivoting end, each of said first lever and said second lever having at said gripping end one of two grasping faces facing each other;
d. a joint connecting said first and said second lever at said pivoting end rotatably around a pivoting axis;
e. a first guiding face extending in an offset from said gripping end from said first lever towards said second lever, said first guiding face facing substantially in axial direction with respect to said pivoting axis;
f. a second guiding face extending in said offset from said gripping end from said second of said two levers, said second guiding face being in guiding interaction with said first guiding face such that a deviation torque is communicated between said levers via said first guiding face and said second guiding face; and
g. a connector cable receiving channel positioned in between said first lever and said second lever and in between said gripping end and said pivoting end, said connector cable receiving channel being longitudinally aligned with said two grasping faces.

2. The connector handling tool of claim 1, wherein said first and said second lever provide with their respective outside faces:
a. a first taper tapering down towards said pivoting end such that a tool grasping force between said two grasping faces is amplified while said connector handling tool is hand held pushed via said first taper in direction towards said gripping end, wherein said first taper is adjacent said pivoting end such that a first boundary contour increase of at least one of said first lever and said second lever increases in direction away from said pivoting end;
b. a second taper tapering down towards said gripping end such that said tool grasping force is amplified while said connector handling tool is hand held pulled via said second taper in direction away from said gripping end, wherein said second taper is adjacent said gripping end such that a second boundary contour increase of at least one of said first lever and said second lever increases in direction away from said gripping end adjacent said gripping end; and
wherein said first boundary contour increase and said second boundary contour increase towards a manual clamping force center of said at least one of said first and said second lever provide for a balanced bending stress distribution of said at least one of said first and said second lever between said gripping end and said pivoting end.

3. The connector handling tool of claim 2, wherein at least one of said first taper and said second taper is in plane with a grasping plane of said connector handling tool.

4. The connector handling tool of claim 2, wherein at least one of said first taper and said second taper is a two dimensional taper.

5. The connector handling tool of claim 1, wherein said first guiding face is provided by a post protruding from a first inner face of said first lever and extending into a cavity embedded in a second inner face of said second lever, said cavity providing said second guiding face.

6. The connector handling tool of claim 5, wherein two of said post are provided adjacent to each other arrayed with a channel spacing substantially in direction axially with respect to said pivoting axis thereby defining said connector cable receiving channel.

7. The connector handling tool of claim 1, wherein a resilient ratcheting force is provided by said first lever on a first ratchet face in direction towards and opposed by a second ratchet face while interacting with said first ratchet face, wherein said first ratchet face and said second ratchet face provide a ratchet closure in combination with said resilient ratcheting force and an externally accessible disengaging feature, wherein said first ratchet face is disengaged from said second ratchet face via said disengaging feature by externally actuating said disengaging feature against said ratcheting force.

8. The connector handling tool of claim 7, wherein said first ratchet face is provided by a post protruding from said disengaging feature and extending into a cavity embedded in a second inner face of said second lever, wherein said second ratchet face is provided by said cavity, and wherein said disengaging feature is in a hinging connection with said first lever.

9. The connector handling tool of claim 8, wherein two of said disengaging features are oppositely placed on opposing side faces of said first lever such that respective ratcheting forces are externally overcome by opposing neutralizing external disengaging forces, and wherein two posts of said two disengaging features are arrayed with a channel spacing substantially in direction axially with respect to said pivoting axis thereby defining said connector cable receiving channel.

10. The connector handling tool of claim 1, wherein at least one of said first grasping face and said second grasping face are provided by a rubber layer.

11. The connector handling tool of claim 10, wherein said rubber layer has a perforation for selectively grasping said connector.

12. The connector handling tool of claim 10, wherein said rubber layer is removable attached to a corresponding of said at least one of said first lever and said second layer via an adhesive layer.

13. The connector handling tool of claim 10, wherein said rubber layer is removable attached to a corresponding of said at least one of said first lever and said second layer via a velcro layer.

14. The connector handling tool of claim 1, wherein at least one of said first grasping face and said second grasping face are provided by a grasping boot removable snapped on at least one correspondingly shaped boot receiving nose of said first lever and said second layer.

15. The connector handling tool of claim 14, wherein at least one of said first grasping face is two dimensionally shaped.

16. The connector handling tool of claim 14, wherein said grasping boot has an on-boot cable receiving channel.

17. The connector handling tool of claim 16, wherein said on-boot cable receiving channel is provided by two boot posts.

18. The connector handling tool of claim 14, wherein said grasping boot has an inner guiding face being part of a guiding interaction with an outward pointing boot guiding face of one corresponding other of said grasping boot.

19. The connector handling tool of claim 1, wherein at least one of said first lever and said second lever provides an integrated flash light pointing substantially tangential towards said gripping end, wherein a housing of said integrated flash light is integrated in a bending stress communicating fashion in said at least one of said first lever and said second lever.

20. The connector handling tool of claim 1, further comprising a joint lever laterally attached to said joint via a joint axle.

21. The connector handling tool of claim 20, wherein said axle includes a screw and nut axially threaded on said screw, wherein one of said screw and said nut is rotationally secured in said joint and one other of said screw and said nut is rotationally connected with said joint lever, wherein said joint lever is rotationally snap guided in said joint such that said joint lever may be rotated at least between a joint lock position and a joint release position and snaps into said lock position and said release position, wherein in said lock position said nut and said screw are tightened with respect to each other such that said joint is rotationally fix, and wherein in said release position said joint is said rotational free.

22. The connector handling tool of claim 20, wherein said joint lever is a pocket clip.

23. The connector handling tool of claim 1, further comprising a latching pin lock in between said first lever and said second lever, said latching pin lock including a latching pin extending substantially parallel with respect to the said pivot axis, wherein both ends of said latching pin are externally accessible for moving said latching pin along a latching cam of said first lever for interlocking with a closure hook of said second lever while said second lever and said first lever are in a connector grasping position with respect to each other.

24. A connector grasping boot comprising,
a. a cavity fit snugly fitting a receiving nose of connector handling tool;
b. a snapping member for snap engaging with a corresponding feature of said connector handling tool;
c. a grasping face for grasping a connector.

25. The connector handling tool of claim 24, said grasping face is two dimensionally shaped.

26. The connector handling tool of claim 24, wherein said grasping boot has an on-boot cable receiving channel.

27. The connector handling tool of claim 26, wherein said on-boot cable receiving channel is provided by two boot posts.

28. The connector handling tool of claim 24, wherein said grasping boot has an inner guiding face being part of a guiding interaction with an outward pointing boot guiding face of one corresponding other of said grasping boot.

29. The connector handling tool of claim 24, wherein said grasping boot has an outward pointing boot guiding face.
